(19) United States
(12) Patent Application Publication
(10) Pub. No.: US 2024/0151050 A1
(43) Pub. Date: May 9, 2024

(54) REINFORCEMENT OF WALL STRUCTURES USING SOLIDIFIABLE MATERIAL

(71) Applicant: ICON Technology, Inc., Austin, TX (US)

(72) Inventor: Ian Bungane Mehlomakulu, Austin, TX (US)

(73) Assignee: ICON Technology, Inc., Austin, TX (US)

(21) Appl. No.: 18/379,739

(22) Filed: Oct. 13, 2023

Related U.S. Application Data
(60) Provisional application No. 63/379,314, filed on Oct. 13, 2022.

(51) Int. Cl. E04G 21/04; B28B 1/00; B33Y 10/00; B33Y 80/00; E04G 21/12

(52) U.S. Cl. CPC E04G 21/0427; B28B 1/001; B33Y 10/00; B33Y 80/00; E04G 21/12

(57) ABSTRACT

Techniques for three dimensional printing of reinforced wall structures using extruded solidifiable material includes printing a first wythe that comprises a first plurality of stacked elongated beads of extruded material, printing a second wythe that comprises a second plurality of stacked elongated beads of extruded material, and building a porous layer disposed between the first wythe and the second wythe. In some examples, embedded reinforcement using mesh, wire, rebar, or other horizontally, diagonally, or vertically-emplaced members may also be performed, where the embedded reinforcement is placed between wythes or within (e.g., disposed within a bead of material, embedded reinforcement is placed) individual beads of a wythe.

### CROSS-REFERENCE TO RELATED APPLICATIONS

This nonprovisional patent application claims the benefit of copending U.S. Provisional Patent Application No. 63/379,314, filed on Oct. 13, 2022 and titled, “METHOD OF REINFORCING WALL STRUCTURES OF SOLIDIFIABLE MATERIAL,” all of which is herein incorporated by reference in its entirety for all purposes.

### FIELD

The present disclosure relates to three-dimensional printing of business structures. More particular, this disclosure is directed to reinforcing stacked layers of extrudable building material to form a reinforced wall structure of the building.

### BACKGROUND

Conventional building structures (e.g., building, dwelling, shed, home, etc.) are constructed using a multitude of different materials and construction methods relying heavily upon the use of wood, concrete, aluminum, steel, and other materials that are framed, fastened, or poured. Among the materials commonly used in the construction of a building structure is concrete or cement, typically poured or formed using molds and frames. For example, conventional uses of cementitious material may be mixed with water and other dry ingredients in cement mixing equipment and vehicles to form a structural foundation upon which interior or exterior walls can be framed for a building. However, conventional solutions for building structures suffer from a number of problems including difficulties using cementitious materials to build structural elements beyond foundations, consuming enormous amounts of materials such as metal and lumber, slow construction times, all of which can be costly in materials, skilled labor, and climatological impacts.

Building structures (e.g., dwellings, buildings, sheds, etc.) using conventional techniques and technologies typically use a multitude of different materials and construction methods. Traditionally, a building structure may be constructed upon a composite slab or foundation that comprises concrete reinforced with re-bar or other metallic materials. Conventionally, a structure is framed (e.g., with wood and/or metal framing members) and an outer shell and interior coverings (e.g., ply-wood, sheet rock, etc.) is typically constructed around the structural framing. Utilities (e.g., water and electrical power delivery as well as vents and ducting for air conditioning and heating systems) are typically enclosed within the outer shell and interior covers along with insulation. Conventional solutions typically use multiple construction steps that cannot be performed simultaneously and often employ numerous personnel with different skills and trades. As a result, conventional solutions for designing and constructing buildings and other structures can occur over a considerable period of time (e.g., 6 months to a year or more) be labor-intensive, and expensive. Drawbacks of using conventional techniques are lengthy construction periods that are often unfeasibly expensive. Thus, what is needed is a solution for building structures using cementitious materials, without the limitations of conventional solutions.

### SUMMARY

The present disclosure relates to a building structure and method of forming a building structure with a reinforced porous material.

In accordance with a first aspect, a three-dimensional (hereafter used interchangeably with “3D”) printed building structure may include a first wythe that has a first plurality of stacked elongated beads of extruded building material. A second wythe may have a second plurality of stacked elongated beads of extruded building material. A porous layer may be disposed between the first wythe and the second wythe.

In accordance with a second aspect, a method of forming a building structure may include forming, with a three-dimensional (3D) printing system, a first wythe comprising a first plurality of stacked elongated beads of an extrudable building material. The method may include forming, with the 3D printing system, a second wythe that comprises a second plurality of stacked elongated beads of the extrudable building material. Finally, the method may include positioning a porous layer between the first wythe and the second wythe.

In further accordance with any one or more of the foregoing first and second aspects, a method of three-dimensional printing may further comprise any one or more of the following aspects.

In some examples, a combined thickness of a first wythe, a second wythe, and a porous layer may be approximately a width of a double bead.

In another example, a first elongated bead of a first plurality of stacked elongated beads may overlap with a second elongated bead of a second plurality of stacked elongated beads.

In some examples, a porous layer may be embedded in one or more of a first elongated bead and a second elongated bead.

In other examples, a porous layer may be a carbon-fiber mesh.

In some forms, a porous layer may connect a first wythe to a second wythe.

In other forms, a method may include embedding a porous layer in one or more of the first and second wythes.

In some examples, a method may include choosing a size of a porous layer based on the 3D printing system.

In other examples, a method may include fixing a porous layer at a location adjacent to an end of the print path.

In some examples, a method may include coupling a porous layer to a support member disposed adjacent to the end of the print path.

In another example, positioning a porous layer may include suspending a carbon fiber mesh from the support member.

In some examples, a method may include filling a space between the support member and one or more of the first and second wythes with a building material.

In other examples, forming a first wythe and a second wythe may include overlapping a first elongated bead of the first plurality of stacked elongated beads with a second elongated bead of the second plurality of stacked elongated beads.

In some forms, a method may include positioning a different porous layer between a first wythe and a second wythe when the first and second wythes reach a height of the porous layer.

In another form, the method may include coupling the different porous layer to the support member.

In some examples, the method may include overlapping an edge of the different porous layer with an edge of the porous layer.

The details of one or more implementations of the subject matter described in this disclosure are set forth in the accompanying drawings and the description below. Other features, aspects, and advantages of the subject matter may become apparent from the description, the drawings, and the claims.

### BRIEF DESCRIPTION OF THE DRAWINGS

FIG. 1 is a perspective view of a three-dimensional (3D) construction system and a building structure being formed by the 3D construction system using printed, stacked layers of elongated beads in accordance with teachings of the present disclosure;

FIG. 2 is a partial front view of the structure, and a block diagram of a control system for controlling the printing of stacked beads that form a wall structure in accordance with teachings of the present disclosure;

FIG. 3 is an expanded breakaway view along region 3 of FIG. 2, showing the elongated beads of the wall structure that, when stacked, form one or more wythes of a wall structure in accordance with teachings of the present disclosure;

FIG. 4 is a perspective view of a different building structure being formed by the 3D construction system using printed, stacked layers of elongated beads in accordance with teachings of the present disclosure;

FIG. 5 is a first layer of the building structure of FIG. 4;

FIG. 6 is a second layer of the building structure of FIG. 4;

FIG. 7 is a third layer of the building structure of FIG. 4;

FIG. 8 is the third layer of FIG. 7 with concrete or cement fill, forming a foundation of the building structure of FIG. 4;

FIG. 9 is the foundation of FIG. 8 with a plurality of stacked elongated beads, forming a reinforced joist;

FIG. 10 is a partial, cross-sectional view of the wall structure of FIG. 9;

FIG. 11 is a top perspective view of multiple layers of elongated beads of a different example implementation of a wall structure in accordance with teachings of the present disclosure; and

FIG. 12 is a schematic illustration of an example control system for a 3D construction system used to construct a wall structure in accordance with teachings of the present disclosure.

### DETAILED DESCRIPTION

Various embodiments or examples may be implemented in numerous ways using various elements, including a system, a process, an apparatus, a user interface, or a series of program code or instructions on a computer readable medium such as a storage medium or a computer network including program instructions that are sent over optical, electronic, electrical, mechanical, chemical, wired, or wireless communication links. In general, individual operations or sub-operations of disclosed processes may be performed in an arbitrary order, unless otherwise provided in the claims.

A detailed description of one or more examples is provided below along with accompanying figures. This detailed description is provided in connection with various examples, but is not limited to any particular example. The scope is limited only by the claims and numerous alternatives, modifications, and equivalents. Numerous specific details are set forth in the following description in order to provide a thorough understanding. These details are provided for the purpose of illustrating various examples and the described techniques may be practiced according to the claims without some or all of these specific details. For clarity, technical material that is known in the technical fields and related to the examples has not been described in detail to avoid unnecessarily obscuring the description or providing unnecessary details that may be already known to those of ordinary skill in the art.

Accordingly, embodiments disclosed herein include construction systems, methods of construction, and even methods for structure design that allow a building structure to be constructed in a fraction of the time associated with traditional construction methods. In particular, embodiments disclosed herein utilize additive manufacturing techniques (e.g., three-dimensional (3D) printing) in order to produce a building more quickly, economically, and in a systematic manner. Three-dimensional printing generally involves movement of a printing assembly, and a nozzle of the printing assembly, in three axes of movement across a horizontal surface of a wall structure having inner and outer members. The wall structure is therefore built layer-by-layer from the ground or foundation upward. As the wall is being built, or printed, the nozzle may periodically turn off and extruded building material may cease exiting the outlet to leave openings in the wall for the windows, doors, etc.

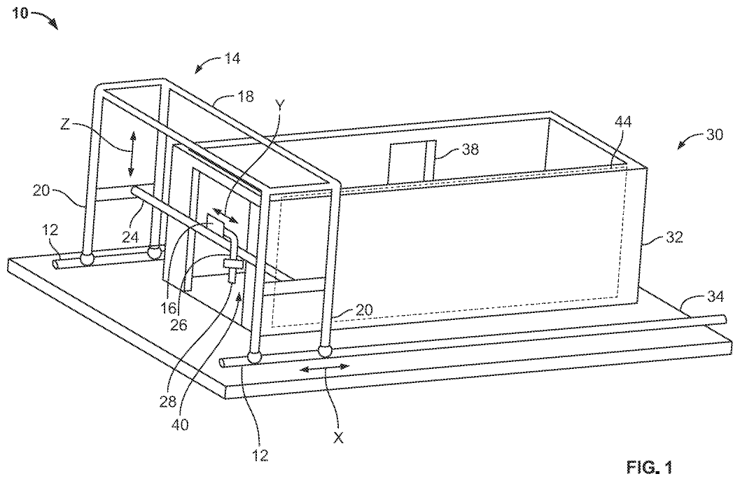

FIG. 1 is a perspective view of a construction system and a building structure being formed by the construction system using printed, stacked layers of elongated beads and an embedded reinforcing mesh or grid between the layers in accordance with the present disclosure. Referring to FIG. 1, a construction system 10 according to one embodiment is shown. Although there are multiple types of 3D additive construction systems contemplated herein, one example of a construction system 10 includes a gantry-type construction system. Other example construction systems can include a single tower and boom to deliver stacked layers of elongated beads onto an existing surface (e.g., a slab or foundation). In some examples, stacked layers of elongated beads may form a wythe or various patterns using multiple wythes. In some examples, when stacked layers of elongated, printed (i.e., extruded as from a three-dimensional (3D) printer, as described herein) beads are formed alongside others, embedded reinforcement or other reinforcing means may be used such as placing rebar or other types of structural support members (e.g., rods, mesh, or the like) between beads (e.g., horizontally, vertically, orthogonally, diagonally, or in other configurations, without limitation or restriction). In other examples, embedded reinforcement may also be placed or disposed within a bead, such as printing a bead around a structural support member as cementitious material is extruded (not shown).

An exemplary construction system 10 can include a pair of railed assemblies 12, a gantry 14 moveably disposed on rail assemblies 12, and a printing assembly 16 moveably disposed on the gantry 14. For example, the gantry 14 may include a bridge support 18 connected between a pair of vertical supports 20. Also, coupled between the vertical supports 20 may be a trolly bridge 24, on which the printing assembly is 16 is moveably disposed.

For example, the gantry 14 can move in the y-axis or y direction along the rail assemblies 12, and the printing assembly 16 can move along the x-axis or x direction along the trolly bridge 24. To complete the three orthogonal axes or dimensions of movement for the printing assembly 16, the trolly bridge 24 can move vertically up and down along the z-axis. For example, the trolly bridge 24 can move up and down in the z-axis upon the vertical support members 20. The x-axis is orthogonal to the y-axis and the z-axis is orthogonal to the plane formed by the x and y axes. Movement along the x, y and z-axes of the printing assembly 16 can occur via drive motors coupled to drive belts, chains, cables, etc., controllably from an instruction-driven processor within a peer system or controller.

The construction system 10 effectuates the construction of a building structure 30 by passing the printing assembly 16 above a wall structure 32 and emitting extruded building material from a nozzle 26 including an outlet 28. Accordingly, as printing assembly 16 moves in three possible orthogonal axes, as well as angles there between, the outlet 28 emits extruded building material onto an upper surface of the wall structure 32 as during formation. The wall structure 32 is formed layer-by-layer by laying down an elongated bead of extruded, solidifiable material, such as, for example, a cementitious material of cement or concrete, beginning with the first layer on ground or a pre-existing foundation 34.

In some examples, as each layer of elongated beads is laid down onto the foundation 34 or onto a previous layer, a plurality of stacked elongated beads of extruded building material additively, and three-dimensionally, form a building structure 30. When the printing assembly 16, and thereby the outlet 28 approaches an opening, such as a window opening 38, or a door opening 40, the pump for the extruded building material stops, and possibly a valve coupled to the outlet 28, or elsewhere, shuts off the flow of extruded material, and does not resume the flow until after the outlet 28 moves past the opening where the wall structure 32 may be resumed.

The foundation 34 can be made of concrete with metallic rods (e.g., rebar) within the foundation form (as mentioned above, embedded support such as rebar may also be emplaced within or between extruded beads to provide structural support or reinforcement). Alternatively, the foundation 34 can simply be ground, possibly packed gravel or crushed rock, a 3D printed foundation, or otherwise. In some aspects, however, the upper surface of the foundation 34 should be substantially planar at its top surface and of sufficient perimeter size to accommodate 3D printing of the wall structure 32 thereon. The axes, labeled as x, y and z, are orthogonal axes in three dimensions; however, it is contemplated that printing assembly 16 and thus outlet 28 of the nozzle 26 can move in three dimensions to form a wall structure at various three-dimensional angles that can be, but need not be, orthogonal angles for the wall structure 32. As described in greater detail below, wall structure 32 includes an embedded mesh, grid, or member (e.g., vertically or horizontally disposed as an embedded support member) 44 disposed between adjacent, vertical stacks of elongated beads to fuse or connect the adjacent stacks together. Nozzle 26 of the printing assembly 16 is arranged to print on either side of the mesh 44 by moving around structural supports that hold the mesh 44 in place. As used herein, the mesh 44 may be referred to as a “grid,” “porous layer,” “embedded reinforcement,” or “reinforcing layer” and may be implemented using wires, mesh, rebar, individual or multiple members, or others, without limitation or restriction.

In this example implementation, FIG. 1 shows an interior (or inner) wall structure 32 that can be used to bifurcate rooms of a building 30 using the construction system 10. For example, in some aspects, the interior wall structure 32 can have a first shell and a second shell (each defined by a wythe of stacked elongated beads), with both the first and second shells exposed to a human-occupiable, indoor, temperature-controlled environment. Thus, in some aspects, the sides of the interior wall structure 32 are not exposed (as designed) to an outdoor ambient environment. However, in alternative embodiments, the wall structure 32 can be an exterior wall structure, such that with the first shell is exposed (e.g., solely) to a human-occupiable, indoor, temperature-controlled environment and the second shell is exposed (e.g., solely) to an outdoor, ambient environment. In some aspects, both the first and second shells can be exposed to an outdoor, ambient environment.

The wall structure 32, in some aspects, can form at least a portion of a non-load bearing wall (also referred to as a “partition wall” or “partition wall structure” in the present disclosure). For example, in some aspects, the wall structure 32, when fully formed and cured, is sufficient to bear its own weight (e.g., holds itself upright, as well as appurtenances such as door frames, window frames, and household items fastened to the structure), but is insufficient to bear (without deformation or collapse or other movement) loads (e.g., on a top surface of the wall structure 32 with respect to gravity) including but not limited to compressive, flexural, shear, and uplift onto the wall structure 32. For example, the wall structure 32 may not be capable of bearing the load of a ceiling structure in the building or a roof in which the wall structure 32 is constructed.

In some aspects, the wall structure 32 can form at least a portion of a load-bearing wall. For example, in some aspects, the wall structure 32, when fully formed and cured, is sufficient to bear (without deformation or collapse or other movement) loads (e.g., on a top surface of the structure 32 with respect to gravity) including but not limited to compressive, flexural, shear and uplift onto the wall structure 32. For example, the wall structure 32 can bear the load of a ceiling structure in the building or a roof in which the wall structure 32 is constructed.

As used herein, a ceiling structure can be a planar or angular structure that separates a human-occupiable, indoor, temperature-controlled environment from another indoor, temperature-uncontrolled environment (e.g., an attic or crawlspace). As another example, as used herein, a ceiling structure can be a planar or angular structure that separates a human-occupiable, indoor, temperature-controlled environment from another indoor, temperature-controlled environment (e.g., a separate floor of a multi-floor building). However, a ceiling structure does not include a roof that separates a human-occupiable, indoor, temperature-controlled (or uncontrolled) environment from an outdoor ambient environment. Thus, the wall structure 32 can be a partition wall structure in that it is insufficient to bear the weight of all or part of a roof structure and/or a load-bearing structure in that it is sufficient to bear the weight of all or part of a roof structure, wind loads, uplift, shear or other loads experienced by building structures.

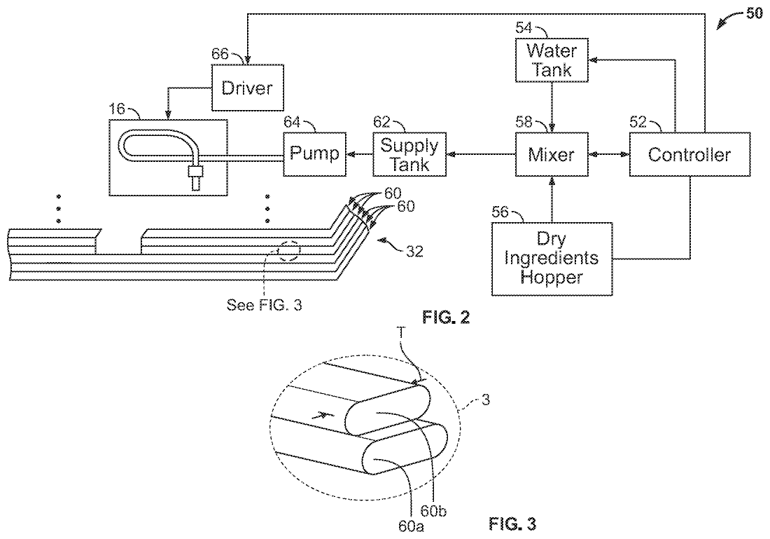

FIG. 2 is a partial front view of the structure, and a block diagram of a control system for controlling the printing of stacked beads that form a wall structure according to the present disclosure. Referring to FIG. 2, a control system 50 is shown in block diagram for controlling the printing of the stacked elongated beads 60 of the wall structure 32. The control system 50 includes a computer system, or controller 52, that contains memory and an instruction set for adding the proper amount of water or liquid mix material from a water tank 54, and dry ingredients from a hopper 56 into a mixer 58. Possibly using a feedback sense mechanism, the controller can adjust the mix of the concrete material and thus the proper proportions of water (or liquid) to dry material, and supply that proper mix to a supply tank 62.

It may be desirable for the stacked elongated beads to be at the proper cross-sectional dimension which is approximately 1.5 to 2.5 inches in lateral width (e.g., parallel to the horizontal plane) and at least approximately 0.5 inches tall (e.g., perpendicular to the horizontal plane). The horizontal plane is preferably along a plane formed by the x and y axes, and the orthogonal dimension thereto is preferably along the z-axis or dimension. To maintain the proper cross-sectional dimension in the horizontal plane so that when the elongated beads are stacked, the inner and outer surfaces are relatively even in texture and somewhat smooth. The pump 64 can be used to supply a proper volume of extruded material to supplement the proper viscosity from the mixer 58. The controller 52 thereby controls not only the proper flow and viscosity of the elongated bead as printing occurs (e.g., material is extruded from a 3D printer), one on top of the other, but the controller 52 also controls movement of the printing assembly 16 in the x, y and z dimensions via a driver 66. The driver 66 can be a motor coupled to any drive mechanism that moves the corresponding trolly bridge 24, gantry 14, and printing assembly 16 on the trolly bridge 24 according to the instruction CAD layout, and to the proper speed, established by the instructions stored in controller 52.

Turning now to FIGS. 2 and 3 in combination, FIG. 3 illustrates an expanded breakaway view along region 3 of FIG. 2. Specifically, FIG. 3 illustrates the elongated beads stacked on top of one another to form a plurality of vertically stacked elongated beads 60. In the example shown, elongated bead 60b is stacked upon elongated bead 60a. As the printing process continues, another elongated bead may be stacked upon bead 60b, and so on. If one bead is stacked upon another bead, then the ensuing wall structure 32 may be one bead width in thickness, labeled T. As noted above, a wythe is a continuous plurality of vertically stacked elongated beads, and a wythe can be a single wythe of thickness T, or a multiple wythe of multiple thicknesses T depending how many elongated beads are placed adjacent one another during the printing process. Accordingly, a wythe may be one or more beads width in thickness, whereas a pair of wythes may be two or more beads in thickness.

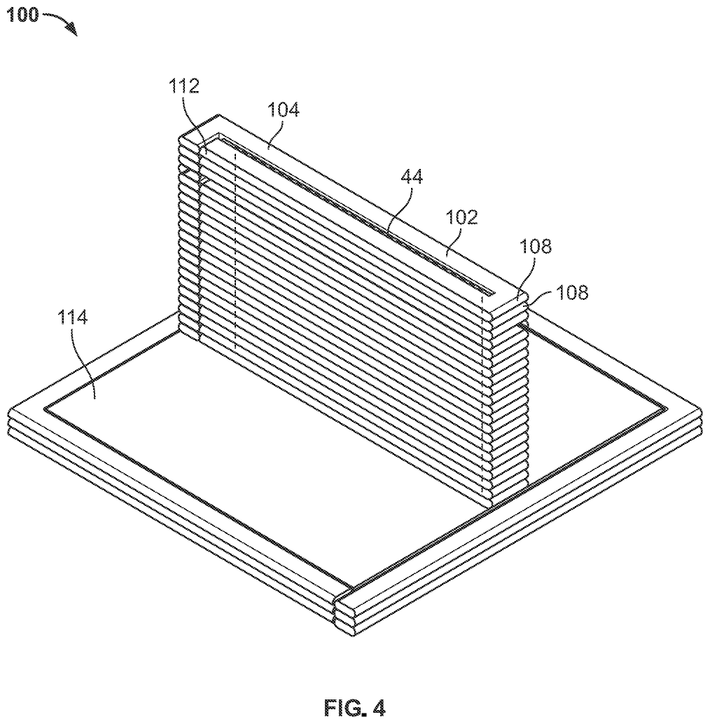

FIG. 4 is a bottom, perspective view of a building structure 100 having a reinforced, self-supporting joist 102. The joist 102 includes a first wythe 104 of a first plurality of stacked elongated beads 108 of extruded building material, a second wythe 112 of a second plurality of stacked elongated beads 108 of extruded building material, and a porous layer 44 disposed between the first wythe 104 and the second wythe 112. In the illustrated example, the first and second plurality of stacked elongated beads 108 may be printed in a continuous method such that the printing head does not stop and start to form each elongated bead 108 and/or wythe 104, 112. In this way, the joist 102 extends continuously from a base 114 of the building structure 100. However, in other examples, each wythe 104, 112 and/or each elongated bead may be formed separately.

FIG. 4 depicts the building structure 100 in an upside-down orientation, which is the orientation in which the building structure 100 is 3D printed. In the example shown in FIG. 4, the building structure 100 is a load-bearing wall structure (e.g., joist, column, beam, truss, etc.) that forms part of the foundation or internal structure of a building. The joist 102 includes two wythes 104, 112 of multiple, stacked elongated beads 108 of an extrudable building material. However, in some aspects, the building structure 100 may be a non-load-bearing wall structure (e.g., partition wall structure) that can be used as an interior wall structure (such as wall structure 32, e.g., an interior, non-load bearing wall structure or partition wall structure).

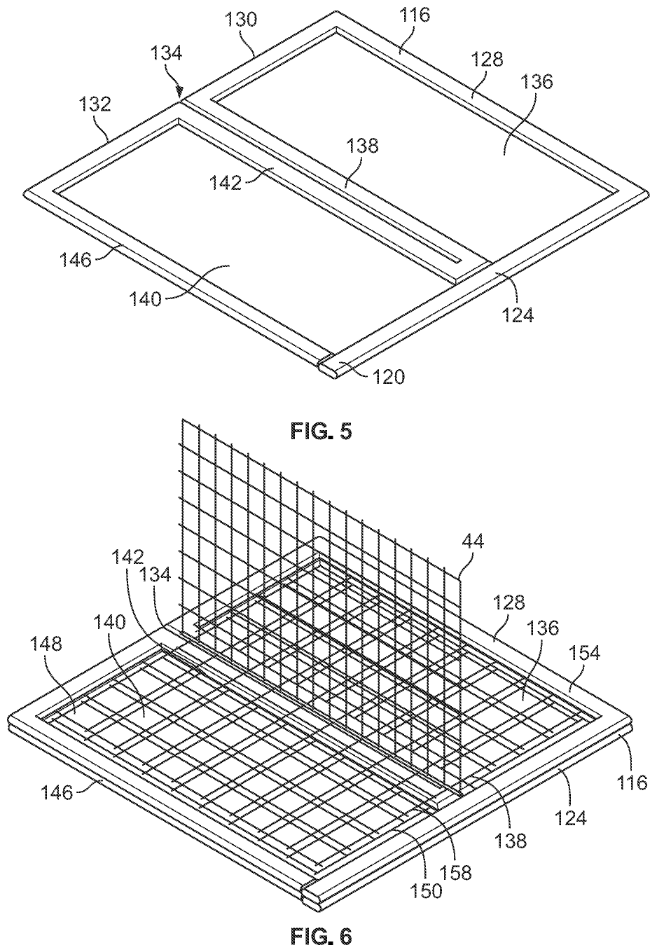

Turning to FIG. 5, a first step of forming the building structure 100 of FIG. 4 is illustrated. A 3D printer continuously prints a first foundation layer 116 of extrudable building material along a printing path. In the illustrated example, a 3D printer may being at starting point 120 and travel along the printing path to form the foundational layer 116 in one continuous step. The foundation layer 116 includes a first side 124, a second side 128, a first portion 130 of a third side 134, a first interior side 138, a second interior side 142, a second portion 132 of the third side 134, and a fourth side 146. Accordingly, the printing path begins at the starting point 120, extends along the first side 124, the second side 128, and the first portion 130 of the third side 134. The printing path continues along the first interior side 138, the second interior side 142, the second portion 132 of the third side 134, the fourth side 146, and returning to the starting point 120. The foundation layer 116 defines a rectangular outer perimeter of the base 114 with a first cavity 136 adjacent to the first interior side 138 and a second cavity 140 adjacent to the second interior side 142. In this example, the first side 124 is perpendicular to second and fourth sides 128, 146, and is parallel to the third side 134.

In another step illustrated in FIG. 6, a pan 148 is formed by placing a first grid layer 150 on the first foundation layer 116, printing a second foundation layer 154, and placing a second grid layer 158 on the second foundation layer 154. At this step, the porous layer 44 is positioned at a seam of the first and second interior sides 138, 142 and oriented perpendicularly relative to the first and second grid layers 150, 158. The porous layer 44 is suspended or attached to the base 114 in one or more sections so that the porous layer 44 can be incorporated into the joist 102 as the wythes 104, 112 are fabricated. The porous layer 44 may be a carbon-fiber mesh or other suitable material, such as a porous metal grid, fiberglass, Kevlar, or other woven composite material, to reinforce the joist 102 and permit the wythes 104, 112 to connect to one another.

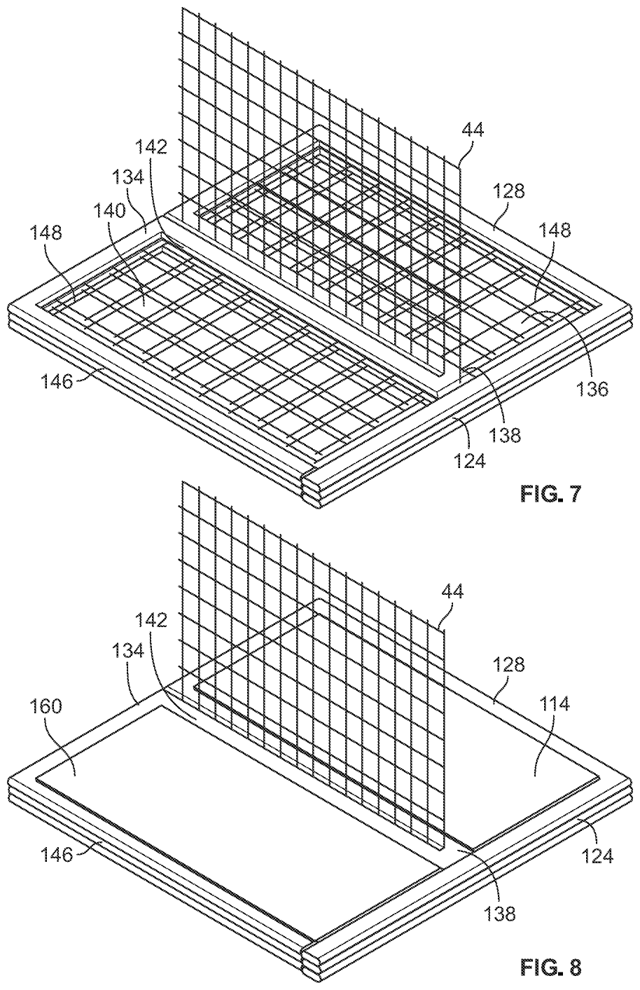

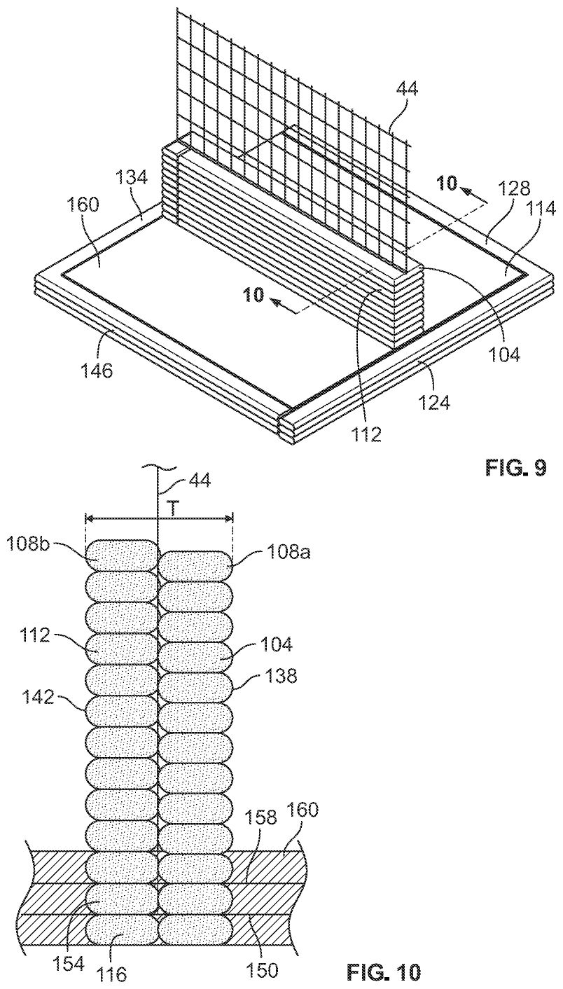

In a subsequent step shown in FIG. 7, a third layer 162 of extrudable building material is printed on top of the second foundation layer 154 in the same or similar manner as the method of printing the first and second foundation layers 116, 154. A step of completing the base 114 in FIG. 8 may include pouring concrete 160 or other material into the first and second cavities 136, 140 to height that is substantially level to an upper surface of the third layer 162. Here, the porous layer 44 is perpendicularly disposed relative to a flat surface of the base 114. To continue printing the joist 102, shown in FIG. 9, the print head of the 3D printer may move to the third side 134 of the structure 100, and begin continuously printing elongated beads on either side of the porous layer 44. As the elongated beads 108 are deposited adjacent to each other to create the first and second wythes 104, 112, the extrudable building material seeps through the pores of the porous layer 44 to fuse the wythes 104, 112 together, as shown in FIG. 10. In some examples, the elongated beads 108a, 108b slightly overlap.

In FIG. 10, the joist 102 has a combined thickness T of the first wythe 104, the second wythe 112, and the porous layer 44, which is approximately a width of a double bead (i.e., a first elongated bead 108a and a second elongated bead 108b without a space in between). In some cases, the combined thickness T may be less than a double bead due to the overlap of the adjacent wythes 104, 112. At each layer of the joist 102, the porous layer 44 is embedded in one or more of the first elongated bead 108a and the second elongated bead 108b. While the base 114 of the example illustrated in FIGS. 4-10 is manufactured with the joist 102, the joist 102 may be manufactured separately from the base 114 in other examples.

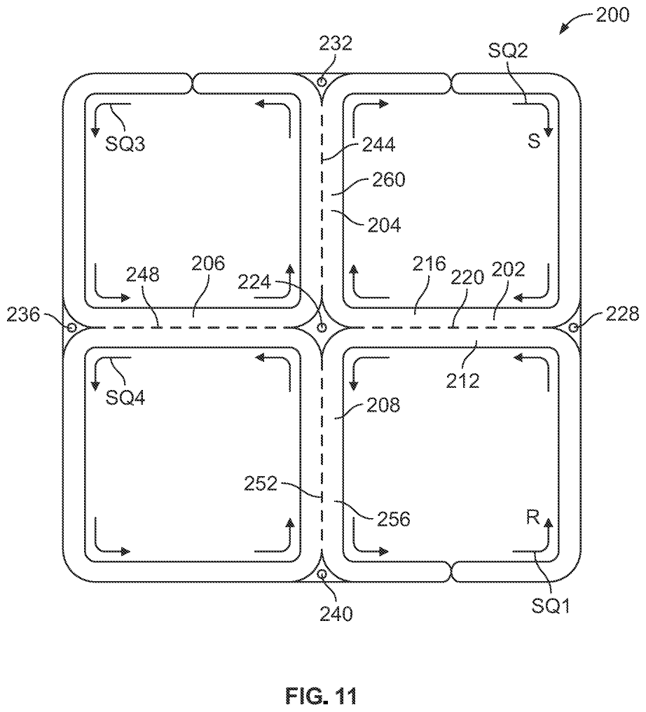

FIG. 11 is a plan view of a second example building structure 200 with a plurality of reinforced, self-supporting joists. Specifically, the building structure 200 includes four separate joists 202, 204, 206, and 208 that are 3D printed using a continuous printing method. Similar to the method described above with respect to FIGS. 4-10, a method of forming a first joist 202 of the building structure 200 of FIG. 11, for example, involves printing a first wythe 212 including a first plurality of stacked elongated beads of an extrudable building material and a second wythe 216 that comprises a second plurality of stacked elongated beads of the extrudable building material. A step of the method includes positioning a porous layer 220, such as, for example, a carbon fiber mesh, between the first wythe 212 and the second wythe 216. Again, similar to the first method described above with respect to the building structure 100 of FIGS. 4-10, the porous layer 220 is positioned between the adjacent wythes 212, 216 as each elongated bead of the plurality of beads of each stack is printed. The print head is arranged to form an overlap between the deposited beads of adjacent wythes 212, 216, and the overlap between the beads embeds the porous layer 220 within the final print material. It may be appreciated that the second, third, and fourth joists 204, 206, and 208 are substantially similar, and thus any details of the first joist 202 discussed herein apply equally to the second, third, and fourth joists 204, 206, and 208.

The building structure 200 and method of printing the building structure 200 of FIG. 11 differs from the first example building structure 100 and method in the following ways. The second building structure 200 includes five spaced apart support members 224, 228, 232, 236, and 240 positioned at ends of four separate print paths SQ1, SQ2, SQ3, SQ4. The support members 224, 228, 232, 236, and 240 are coupled to one or more porous layers 220, 244, 248, and 252 to suspend the porous layers 220, 244, 248, and 252 in a perpendicular orientation relative to horizontal. Specifically, the first, second, third, fourth, and fifth support members 224, 228, 232, 236, and 240 are strategically positioned based on the architectural plans of the building structure 200. In this example, the desired building structure 200 includes four joists 202, 204, 206, 208 constructed in a cross configuration. However, other print geometries may be created by changing the support member locations, serving as the vertices of the desired building shape.

In FIG. 11, the first support member 224 is coupled to ends of first, second, third, and fourth porous layers 220, 244, 248, and 252. Each porous layer 220, 244, 248, and 252 is positioned 90 degrees apart from adjacent porous layers and coupled to a respective support member 228, 232, 236, 240 disposed on an outer perimeter of the building structure 200. Specifically, the first porous layer 220 is coupled to the first support member 224 and the second support member 228, the second porous layer 244 is coupled to the first support member 224 and the third support member 232, the third porous layer 248 is coupled to the first support member 224 and the fourth support member 236, and the fourth porous layer 252 is coupled to the first support member 224 and the fifth support member 240. Each porous layer 220, 244, 248, and 252 may be initially suspended by the first support member 224 and respective outer support member 228, 232, 236, and 240 before printing begins. As the porous layer 220 of the first joist 202, for example, gradually becomes integrated with the adjacent wythes 212, 216, the support members 224, 228 may be extended and an additional porous layer may be added to the support members 224, 228 and suspended above, and overlap with, the embedded porous layer 220 to continue forming and reinforcing the joist 202.

The building structure 200 may be formed using one or more 3D print heads. For example, one 3D print head may travel along the first square printing path SQ1 to form the first wythe 212 of the first joist 202 and a first wythe 256 of the fourth joist 208 in an example direction R. The print head may travel in a direction opposite R, as well. A different 3D print head may travel along the second square printing path SQ2 to form the second wythe 216 of the first joist 202 and a second wythe 260 of the second joist 204 in an example direction S (or in a direction opposite S). Further, another 3D print head may travel along the third square printing path SQ3 to form a first wythe of the second joist 204 and a first wythe of the third joist 206, and another 3D print head may travel along the fourth square printing path SQ4 to form a second wythe of the third joist 206 and a second wythe of the fourth joist 208. While the one or more 3D print heads continuously print, an outer wall portion of the building structure 200 is gradually formed, as well. In contrast to the joists, the outer wall portion has a single bead width. The print heads are arranged to form an overlap between the deposited beads of adjacent wythes of each joist 202, 204, 206, and 208. The overlap between the elongated beads embeds the porous layer 220, 244, 248, and 252 within their respective final joist 202, 204, 206, and 208. The printing paths SQ1, SQ2, SQ3, and SQ4 correspond with the architectural plans of the building structure 200. Accordingly, in other examples, the printing paths of the 3D printing heads may form different shapes according to the building design. In other examples, the building structure 200 may be formed in other ways.

In some examples, a size of each porous layer porous layer 220, 244, 248, and 252 may be chosen based on the 3D printing system (i.e., length of the nozzle, etc.). For example, each porous layer 220, 244, 248, and 252 may be cut to a specified height before being fixed to their respective support members 224, 228, 232, 236, and 240. The specified height of the porous layers 220, 244, 248, and 252 may be determined based upon operational constraints of the printer in use. When the specified height of the porous layer 220 is reached during the printing process, for example, the first and second support members 224, 228 may be extended and an additional porous layer is attached to the support members 224, 228 with any overlapping between the porous layer 220 below and the new piece of porous material.

In each case, the 3D print head is smaller than the final bead width and can continuously print a plurality of stacked elongated beads without interfering with, or running into, the plurality of support members 224, 228, 232, 236, and 240 or with the porous layers 220, 244, 248, and 252. As a result, a pilaster or column void is formed around each support member 224, 228, 232, 236, and 240. When a desired print height for the joist 202, 204, 206, and 208 is reached, the pilasters with the support are either tensioned or filled (e.g., with building material) to meet design requirements as desired.

The methods described herein allow 3D printed building structures to incorporate reinforcing materials, such as, for example, carbon fiber mesh, to form self-supporting walls, beams, joists, or other structures. Carbon fiber meshes or grids are used to reinforce precast panelized systems to strengthen the concrete system and replace rebar reinforcement without increasing structural width. The methods of the present disclosure may form building structures that are no more than two times the single print bead width while tying individual printed layers together, both vertically and horizontally, to provide a sufficient structural connection to bear and transfer structural loads. Each of the building structures 100, 200 includes a self-supporting narrow wall (e.g., a joist) without forming a gap between the adjacent wythes. As a result, the thicknesses of the walls 102, 202 may be approximately two times the single print bead width, thereby maximizing valuable livable or usable building area. Further, the carbon fiber mesh that reinforces the wall portion better resists both shear forces and flexural wall forces in between the pilasters.

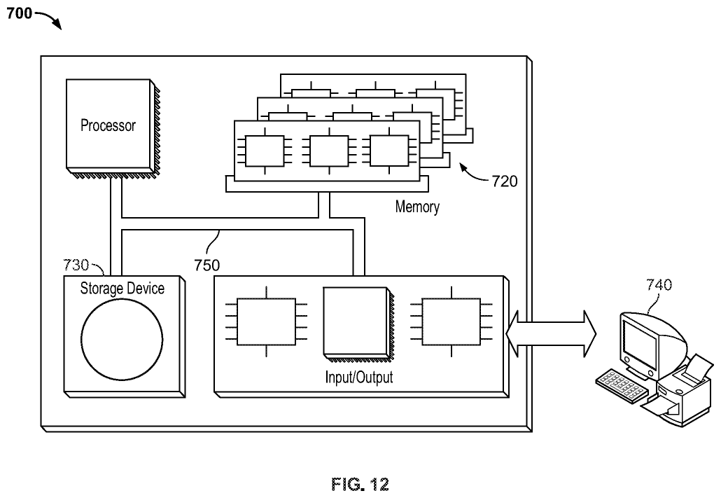

FIG. 12 is a schematic illustration of an example control system for a construction system used to construct a wall structure according to the present disclosure. For example, all or parts of the controller 700 can be used for the operations described previously, for example as or as part of the controller 52. The controller 700 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 700 includes a processor 710, a memory 720, a storage device 730, and an input/output device 740. Each of the components 710, 720, 730, and 740 are interconnected using a system bus 750. The processor 710 is capable of processing instructions for execution within the controller 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the controller 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the controller 700. In one implementation, the storage device 730 is a computer-readable medium. In various different implementations, the storage device 730 may be a floppy disk device, a hard disk device, an optical disk device, a tape device, flash memory, a solid state device (SSD), or a combination thereof.

The input/output device 740 provides input/output operations for the controller 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor may receive instructions and data from a read-only memory or a random access memory or both. The essential elements of a computer are a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

In the present disclosure and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., x, y, or z direction or central axis of a body, outlet or port), while the terms “radial” and “radially” generally mean perpendicular to the given axis. For instance, an axial distance refers to a distance measured along or parallel to the axis, and a radial distance means a distance measured perpendicular to the axis.

As used herein, the terms “about,” “approximately,” “substantially,” “generally,” and the like mean plus or minus 10% of the stated value or range. In addition, as used herein, an “extruded building material” refers to a building material that may be delivered or conveyed through a conduit (e.g., such as a flexible conduit) and extruded (e.g., via a nozzle or pipe) in a desired location. In some embodiments, an extruded building material includes a cementitious mixture (e.g., concrete, cement, etc.).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it may be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed:

1. A three-dimensional printed structure, comprising:
a first wythe that comprises a first plurality of stacked elongated beads of extruded material;
a second wythe that comprises a second plurality of stacked elongated beads of extruded material; and
a porous layer disposed between the first wythe and the second wythe.

2. The three-dimensional printed structure of claim 1, wherein a combined thickness of the first wythe, the second wythe and the porous layer is approximately a width of a double bead.

3. The three-dimensional printed structure of claim 1, wherein a first elongated bead of the first plurality of stacked elongated beads overlaps with a second elongated bead of the second plurality of stacked elongated beads.

4. The three-dimensional printed structure of claim 1, wherein the porous layer comprises embedded reinforcement between the first wythe and the second wythe.

5. The three-dimensional printed structure of claim 1, wherein the porous layer is a carbon-fiber mesh.

6. The three-dimensional printed structure of claim 1, wherein the porous layer couples the first wythe to the second wythe.

7. A method of forming a building structure, comprising:
forming, using a three-dimensional (3D) printing system, a first wythe comprising a first plurality of stacked elongated beads of an extrudable building material;
forming, using the three-dimensional (3D) printing system, a second wythe that comprises a second plurality of stacked elongated beads of the extrudable building material; and
positioning a porous layer between the first wythe and the second wythe.

8. The method of claim 7, further comprising embedding the porous layer in one or more of the first and second wythes.

9. The method of claim 7, further comprising choosing a size of the porous layer based on the three-dimensional (3D) printing system.

10. The method of claim 7, further comprising embedding the porous layer in one or more of the first and second wythes, a size of the porous layer being determined using the three-dimensional (3D) printing system.

11. The method of claim 7, wherein positioning the porous layer comprises reinforcing the porous layer by coupling the first wythe and the second wythe using embedded reinforcement.

12. The method of claim 7, further comprising coupling the porous layer to a support member disposed adjacent to the end of a print path, the print path being used by the three-dimensional (3D) printing system to form the building structure.

13. The method of claim 7, wherein positioning the porous layer comprises suspending a carbon fiber mesh from a support member.

14. The method of claim 7, further comprising coupling the porous layer to a support member disposed adjacent to the end of a print path, the print path being used by the three-dimensional (3D) printing system to form the building structure and filling a space between the support member and one or more of the first and second wythes with a building material.

15. The method of claim 7, wherein positioning the porous layer comprises suspending a carbon fiber mesh from a support member and filling a space between the support member and one or more of the first and second wythes with a building material.

16. The method of claim 7, wherein forming the first wythe and the second wythe comprises overlapping a first elongated bead of the first plurality of stacked elongated beads with a second elongated bead of the second plurality of stacked elongated beads.

17. The method of claim 7, further comprising positioning a different porous layer between the first wythe and second wythe when the first and second wythes reach a height of the porous layer.

18. The method of claim 7, further comprising positioning a different porous layer between the first wythe and second wythe when the first and second wythes reach a height of the porous layer further and coupling the different porous layer to the support member.

19. The method of claim 7, further comprising positioning a different porous layer between the first wythe and second wythe when the first and second wythes reach a height of the porous layer and overlapping an edge of the different porous layer with an edge of the porous layer.
